(19) United States
(12) Patent Application Publication
(10) Pub. No.: US 2024/0060011 A1
(43) Pub. Date: Feb. 22, 2024

(54) FABRIC CONDITIONER

(71) Applicant: Conopco, Inc., d/b/a UNILEVER, Englewood Cliffs, NJ (US)

(72) Inventors: Christopher BOARDMAN, Llandymog (GB); Louise Stephanle CONNELL-FIELDING, Liverpool (GB); Martin Charles CROSSMAN, Eastham, Wirral (GB); John Michael WALSH, Liverpool (GB)

(73) Assignee: Conopco, Inc., d/b/a UNILEVER, Englewood Cliffs, NJ (US)

(21) Appl. No.: 18/270,967

(22) PCT Filed: Dec. 23, 2021
(86) PCT No.: PCT/EP2021/087621

§ 371 Date: Jul. 5, 2023

(30) Foreign Application Priority Data
Jan. 13, 2021 (EP) 21151434.4

(51) Int. Cl. C11D 3/30; C11D 3/00; C11D 11/00; C11D 17/00; C11D 3/50

(52) U.S. Cl. CPC C11D 3/30; C11D 3/001; C11D 11/0017; C11D 17/0039; C11D 3/50

(57) ABSTRACT

A method of preventing or reducing colour fade of fabrics over multiple laundry cycles wherein a composition comprising fabric softening active, pentaerythritol ester oil and perfume is used during the rinse stage of the laundry process. Method of preparing the composition.

### FIELD OF INVENTION

The present invention is in the field of methods for preventing colour fade during consecutive laundry cycles.

### BACKGROUND OF THE INVENTION

The laundry process can cause the colour of dyed fabrics to fade. As colours fade, fabrics appear worn, old and may result in consumers disposing to fabrics before they would have done otherwise. There is a desire for products which keep fabrics looking newer for longer, particular addressing the issue of colour maintenance or colour fade. This would extend the life of clothes which provides a finical benefit to consumers and an overall benefit to the planet by reducing clothing manufacture. The fabric conditioner compositions described herein provide colour care benefits over consecutive laundry cycles, thereby extending the life of clothes.

### SUMMARY OF THE INVENTION

In a first aspect of the present invention is a method of preventing or reducing fabric colour fade of fabrics over multiple laundry cycles wherein a composition comprising:
a. fabric softening active;
b. ester oil; and
c. 0.1 to 30 wt. % perfume materials;
   is used during the rinse stage of the laundry process and wherein the ester oil is a pentaerythritol ester oil.

In a second aspect of the present invention is a method of preparing a composition comprising:
a. fabric softening active; and
b. ester oil.
   wherein the fabric softening active and ester oil are premixed, prior to addition to water. In a third aspect of the present invention is a use of a composition comprising:
a. fabric softening active; and
b. ester oil
   to provide improved colour care or colour maintenance of fabrics.

### DESCRIPTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

Method

Described herein is a method of preventing or reducing fabric colour fade over multiple washes. The method involves treating fabric with a composition comprising a fabric softening active and an ester oil during the laundry process. The treatment is during the laundry cycle. This may be hand washing or machine washing. The fabric conditioner is used in the rinse stage of the laundry cycle. Preferably the fabric is treated with a 10 to 100 ml dose of a composition described herein for a 4 to 7 kg load of fabric. More preferably, 10 to 80 ml for a 4 to 7 kg load of fabric.

The method of preventing colour fade is over multiple wash cycles. i.e. after more than one wash cycle the colour fade is at least partially reduced compared to fabrics laundered not according to this method. Preferably a method of preventing colour fade over 10 laundry cycles, preferably 5, wherein fabrics are treated with the compositions described herein during the laundry cycle, preferably during the rinse phase of the laundry cycle. A single laundry cycle is defined as washing, rinsing, drying and wearing clothes or using fabrics such as sheets or towels.

The compositions described herein and for use in the method may be used as a conventional fabric conditioner. Alternatively, the compositions may be used in a unit dose format, wherein a single dose of the fabric conditioner composition is encapsulated in a water soluble film such as polyvinyl alcohol. Alternatively, the composition may be used in a ‘dilute at home’ product, i.e. a product which is sold to the consumer in a concentrated from and wherein the consumer mixes the composition with water prior to use.

In one aspect of the present invention there is provided the use of the compositions described herein to provide improved colour care or colour maintenance of fabrics. In other words the compositions described herein reduce colour fade over multiple laundry cycles. Preferably this benefit is observable over 10 laundry cycles, more preferably 5 laundry cycles.

The colour benefits described herein are observable on any fabric comprising dyes. However, the colour care benefits are particularly evident for black and green dyes, in particular the method described herein is particularly effective for reactive black dye 5. Colour fade can be measured using a UV Vis spectrometer, for example the Color i7 Benchtop Spectrophotometer ex. X-rite and is reported using the units ΔE.

Fabric Softening Active

The compositions described herein comprise a fabric softening active. Preferably the fabric conditioners of the present invention comprise more than 1 wt. % fabric softening active, more preferably more than 2 wt. % fabric softening active, most preferably more than 3 wt. % fabric softening active by weight of the composition. Preferably the fabric conditioners of the present invention comprise less than 80 wt. % fabric softening active, more preferably less than 70 wt. % fabric softening active, most preferably less than 60 wt. % fabric softening active by weight of the composition. Suitably the fabric conditioners comprise 1 to 80 wt. % fabric softening active, preferably 2 to 70 wt. % fabric softening active and more preferably 2 to 60 wt. % fabric softening active by weight of the composition.

The fabric softening actives may be any material known to soften fabrics. These may be polymeric materials or compounds known to soften materials. Examples of suitable fabric softening actives include: quaternary ammonium compounds, silicone polymers, polysaccharides, clays, amines, fatty esters, dispersible polyolefins, polymer latexes and mixtures thereof.

The fabric softening actives may preferably be cationic or non-ionic materials. Preferably, the fabric softening actives of the present invention are cationic materials. Suitable cationic fabric softening actives are described herein.

The preferred softening actives for use in fabric conditioner compositions of the invention are quaternary ammonium compounds (QAC).

The QAC preferably comprises at least one chain derived from fatty acids, more preferably at least two chains derived from a fatty acids. Generally fatty acids are defined as aliphatic monocarboxylic acids having a chain of 4 to 28 carbons. Fatty acids may be derived from various sources such as tallow or plant sources. Preferably the fatty acid chains are derived from plants. Preferably the fatty acid chains of the QAC comprise from 10 to 50 wt. % of saturated C18 chains and from 5 to 40 wt. % of monounsaturated C18 chains by weight of total fatty acid chains. In a further preferred embodiment, the fatty acid chains of the QAC comprise from 20 to 40 wt. %, preferably from 25 to 35 wt. % of saturated C18 chains and from 10 to 35 wt. %, preferably from 15 to 30 wt. % of monounsaturated C18 chains, by weight of total fatty acid chains.

The preferred quaternary ammonium fabric softening actives for use in compositions of the present invention are so called “ester quats”. Particularly preferred materials are the ester-linked triethanolamine (TEA) quaternary ammonium compounds comprising a mixture of mono-, di- and tri-ester linked components.

Typically, TEA-based fabric softening compounds comprise a mixture of mono, di- and tri ester forms of the compound where the di-ester linked component comprises no more than 70 wt. % of the fabric softening compound, preferably no more than 60 wt. % e.g. no more than 55%, or even no more that 45% of the fabric softening compound and at least 10 wt. % of the monoester linked component.

A first group of quaternary ammonium compounds (QACs) suitable for use in the present invention is represented by formula (I):

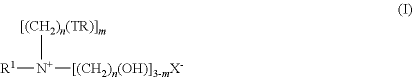

wherein each R is independently selected from a C5 to C35 alkyl or alkenyl group; R1 represents a C1 to C4 alkyl, C2 to C4 alkenyl or a C1 to C4 hydroxyalkyl group; T may be either O—CO. (i.e. an ester group bound to R via its carbon atom), or may alternatively be CO—O (i.e. an ester group bound to R via its oxygen atom); n is a number selected from 1 to 4; m is a number selected from 1, 2, or 3; and X— is an anionic counter-ion, such as a halide or alkyl sulphate, e.g. chloride or methylsulfate. Di-esters variants of formula I (i.e. m=2) are preferred and typically have mono- and tri-ester analogues associated with them. Such materials are particularly suitable for use in the present invention.

Suitable actives include soft quaternary ammonium actives such as Stepantex VT90, Rewoquat WE18 (ex-Evonik) and Tetranyl L1/90N, Tetranyl L190 SP and Tetranyl L190 S (all ex-Kao).

Also suitable are actives rich in the di-esters of triethanolammonium methylsulfate, otherwise referred to as “TEA ester quats”.

Commercial examples include Preapagen™ TQL (ex-Clariant), and Tetranyl™ AHT-1 (ex-Kao), (both di-[hardened tallow ester] of triethanolammonium methylsulfate), AT-1 (di-[tallow ester] of triethanolammonium methylsulfate), and L5/90 (di-[palm ester] of triethanolammonium methylsulfate), (both ex-Kao), and Rewoquat™ WE15 (a di-ester of triethanolammonium methylsulfate having fatty acyl residues deriving from C10-C20 and C16-C18 unsaturated fatty acids) (ex-Evonik).

A second group of QACs suitable for use in the invention is represented by formula (II):

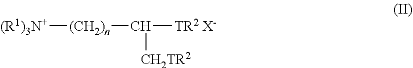

wherein each R1 group is independently selected from C1 to C4 alkyl, hydroxyalkyl or C2 to C4 alkenyl groups; and wherein each R2 group is independently selected from C8 to C28 alkyl or alkenyl groups; and wherein n, T, and X— are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180 (Lever Brothers). Preferably, these materials also comprise an amount of the corresponding mono-ester.

A third group of QACs suitable for use in the invention is represented by formula (III):

(R¹)₂—N⁺—[(CH₂)ₙ-T-R²]₂X⁻ (III)

wherein each R1 group is independently selected from C1 to C4 alkyl, or C2 to C4 alkenyl groups; and wherein each R2 group is independently selected from C8 to C28 alkyl or alkenyl groups; and n, T, and X— are as defined above. Preferred materials of this third group include bis(2-tallowoyloxyethyl)dimethyl ammonium chloride, partially hardened and hardened versions thereof.

A particular example of the fourth group of QACs is represented the by the formula:

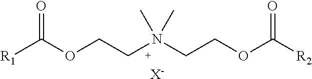

A fourth group of QACs suitable for use in the invention are represented by formula (V)

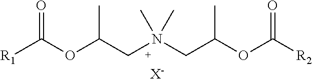

R1 and R2 are independently selected from C10 to C22 alkyl or alkenyl groups, preferably C14 to C20 alkyl or alkenyl groups. X— is as defined above.

The iodine value of the quaternary ammonium fabric conditioning material is preferably from 0 to 80, more preferably from 0 to 60, and most preferably from 0 to 45. The iodine value may be chosen as appropriate. Essentially saturated material having an iodine value of from 0 to 5, preferably from 0 to 1 may be used in the compositions of the invention. Such materials are known as “hardened” quaternary ammonium compounds.

A further preferred range of iodine values is from 20 to 60, preferably 25 to 50, more preferably from 30 to 45. A material of this type is a “soft” triethanolamine quaternary ammonium compound, preferably triethanolamine di-alkylester methylsulfate. Such ester-linked triethanolamine quaternary ammonium compounds comprise unsaturated fatty chains.

If there is a mixture of quaternary ammonium materials present in the composition, the iodine value, referred to above, represents the mean iodine value of the parent fatty acyl compounds or fatty acids of all of the quaternary ammonium materials present. Likewise, if there is any saturated quaternary ammonium materials present in the composition, the iodine value represents the mean iodine value of the parent acyl compounds of fatty acids of all of the quaternary ammonium materials present.

Iodine value as used in the context of the present invention refers to, the fatty acid used to produce the QAC, the measurement of the degree of unsaturation present in a material by a method of nmr spectroscopy as described in Anal. Chem., 34, 1136 (1962) Johnson and Shoolery.

A further type of softening compound may be a non-ester quaternary ammonium material represented by formula (VI):

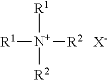

wherein each R1 group is independently selected from C1 to C4 alkyl, hydroxyalkyl or C2 to C4 alkenyl groups; R2 group is independently selected from C8 to C28 alkyl or alkenyl groups, and X— is as defined above.

Ester Oil

The compositions of the present invention preferably comprise ester oils. The ester oils are preferably hydrophobic.

The ester oil may be a sugar ester oil or an oil with substantially no surface activity. Preferably the oil is a liquid or soft solid.

Preferably, the ester oil is a polyol ester (i.e. more than one alcohol group is reacted to form the polyol ester). Preferably the polyol ester is formed by esterification of a polyol (i.e. reacting a molecule comprising more than one alcohol group with acids). Preferably the polyol ester comprises at least two ester linkages. Preferably the polyol ester comprises no hydroxyl groups.

The ester oil is a pentaerythritol ester oil, i.e. an ester oil formed from pentaerythritol e.g. a pentaerythritol tetraisostearate.

Exemplary structures of the compound are (1) and (II) below:

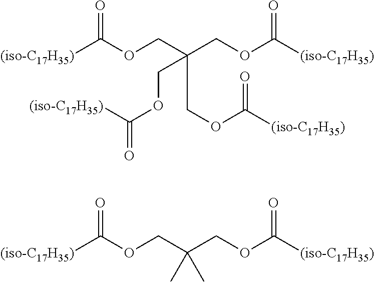

Preferably the ester oil is saturated.

Preferably, the ester oils are esters containing straight or branched, saturated or unsaturated carboxylic acids.

Suitable ester oils are the fatty ester of a mono or polyhydric alcohol having from 1 to about 24 carbon atoms in the hydrocarbon chain and mono or polycarboxylic acids having from 1 to about 24 carbon atoms in the hydrocarbon chain with the proviso that the total number of carbon atoms in the ester oil is equal to or greater than 16 and that at least one of the hydrocarbon radicals in the ester oil has 12 or more carbon atoms.

Preferably the viscosity of the ester oil or mineral oil is from 2 mPa·s to 400 mPa·s at a temperature of 25 C, more preferably a viscosity from 2 to 150 mPa·s, most preferably a viscosity from 10 to 100 mPa·s.

Preferably the refractive index of the ester oil is from 1.445 to 1.490, more preferred from 1.460 to 1.485.

The ester oil of the current invention may be in the form of a free oil or an emulsion.

The ester oil may be encapsulated. Suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred materials are aminoplast microcapsules, such as melamine formaldehyde or urea formaldehyde microcapsules. Suitable microcapsules are disclosed in US 2003215417 In one embodiment, the microcapsules shell maybe coated with polymer to enhance the ability of the microcapsule to adhere to fabric, as described in U.S. Pat. Nos. 7,125,835; 7,196,049; and 7,119,057

The compositions described herein preferably comprise 0.25 to 15 wt. % ester oil. Preferably 0.5 to 10 wt. % ester oil, more preferably 0.5 to 6 wt. % ester oil.

Preferably the ratio of fabric softening active to ester oil is 15:1 to 2:1, more preferably 10:1 to 3:1, even more preferably 8:1 to 4:1. These ratios of fabric softening active to ester oil provide enhanced colour fade reduction.

Perfume

The compositions described herein comprise perfume. The compositions preferably comprise 0.1 to 30 wt. % perfume materials, i.e. free perfume and/or perfume microcapsules. As is known in the art, free perfumes and perfume microcapsules provide the consumer with perfume hits at different points during the laundry process. It is particularly preferred that the compositions of the present invention comprise a combination of both free perfume and perfume microcapsules.

Preferably the compositions of the present invention comprise 0.5 to 20 wt. % perfume materials, more preferably 1 to 15 wt. % perfume materials, most preferably 1 to 10 wt. % perfume materials.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

The compositions of the present invention preferably comprises 0.1 to 15 wt. % free perfume, more preferably 0.5 to 8 wt. % free perfume.

Particularly preferred perfume components are blooming perfume components and substantive perfume components. Blooming perfume components are defined by a boiling point less than 250° C. and a Log P or greater than 2.5. Substantive perfume components are defined by a boiling point greater than 250° C. and a Log P greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

The compositions of the present invention preferably comprise 0.1 to 15 wt. % perfume microcapsules, more preferably 0.2 to 8 wt. % perfume microcapsules. The weight of microcapsules is of the material as supplied.

When perfume components are encapsulated, suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The compositions of the present invention preferably comprise friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a Log P greater than 2.5. Preferably the encapsulated perfume compositions comprises at least 20 wt. % blooming perfume ingredients, more preferably at least 30 wt. % and most preferably at least 40 wt. % blooming perfume ingredients. Substantive perfume components are defined by a boiling point greater than 250° C. and a Log P greater than 2.5. Preferably the encapsulated perfume compositions comprises at least 10 wt. % substantive perfume ingredients, more preferably at least 20 wt. % and most preferably at least 30 wt. % substantive perfume ingredients. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume components may be applied.

The microcapsules may comprise perfume components and a carrier for the perfume ingredients, such as zeolites or cyclodextrins.

Cationic Polymers

The compositions of the present invention may preferably comprise a cationic polymer. Cationic polymers aid deposition of the ester oils. ‘Cationic polymer’ refers to polymers having an overall positive charge. The compositions preferably comprise a cationic polymer at a level of from 0.1 to 5 wt. %, preferably from 0.1 to 4 wt. %, more preferably from 0.1 to 3 wt. %, even more preferably from 0.25 to 2.5 wt. %, most preferably from 0.25 to 1.5 wt. %.

The cationic polymer may be naturally derived or synthetic. Examples of suitable cationic polymers include: acrylate polymers, cationic amino resins, cationic urea resins, and cationic polysaccharides, including: cationic celluloses, cationic guars and cationic starches.

The cationic polymer of the present invention may be categorised as a polysaccharide-based cationic polymer or non-polysaccharide based cationic polymers.

Polysaccharide-Based Cationic Polymers:

Polysaccharide based cationic polymers include cationic celluloses, cationic guars and cationic starches. Polysaccharides are polymers made up from monosaccharide monomers joined together by glycosidic bonds.

The cationic polysaccharide-based polymers present in the compositions of the invention have a modified polysaccharide backbone, modified in that additional chemical groups have been reacted with some of the free hydroxyl groups of the polysaccharide backbone to give an overall positive charge to the modified cellulosic monomer unit.

A preferred polysaccharide polymer is cationic cellulose. This refers to polymers having a cellulose backbone and an overall positive charge.

Cellulose is a polysaccharide with glucose as its monomer, specifically it is a straight chain polymer of D-glucopyranose units linked via beta-1,4 glycosidic bonds and is a linear, non-branched polymer.

The cationic cellulose-based polymers of the present invention have a modified cellulose backbone, modified in that additional chemical groups have been reacted with some of the free hydroxyl groups of the polysaccharide backbone to give an overall positive charge to the modified cellulose monomer unit.

A preferred class of cationic cellulose polymers suitable for this invention are those that have a cellulose backbone modified to incorporate a quaternary ammonium salt. Preferably the quaternary ammonium salt is linked to the cellulose backbone by a hydroxyethyl or hydroxypropyl group. Preferably the charged nitrogen of the quaternary ammonium salt has one or more alkyl group substituents.

Example cationic cellulose polymers are salts of hydroxyethyl cellulose reacted with trimethyl ammonium substituted epoxide, referred to in the field under the International Nomenclature for Cosmetic Ingredients as Polyquatemium 10 and is commercially available from the Amerchol Corporation, a subsidiary of The Dow Chemical Company, marketed as the Polymer LR, JR, and KG series of polymers. Other suitable types of cationic celluloses include the polymeric quaternary ammonium salts of hydroxyethyl cellulose reacted with lauryl dimethyl ammonium-substituted epoxide referred to in the field under the International Nomenclature for Cosmetic Ingredients as Polyquatemium 24. These materials are available from Amerchol Corporation marketed as Polymer LM-200.

Typical examples of preferred cationic cellulosic polymers include cocodimethylammonium hydroxypropyl oxyethyl cellulose, lauryldimethylammonium hydroxypropyl oxyethyl cellulose, stearyldimethylammonium hydroxypropyl oxyethyl cellulose, and stearyldimethylammonium hydroxyethyl cellulose; cellulose 2-hydroxyethyl 2-hydroxy 3-(trimethyl ammonio) propyl ether salt, polyquaternium-4, polyquaternium-10, polyquaternium-24 and polyquaternium-67 or mixtures thereof.

More preferably the cationic cellulosic polymer is a quaternised hydroxy ether cellulose cationic polymer. These are commonly known as polyquaternium-10. Suitable commercial cationic cellulosic polymer products for use according to the present invention are marketed by the Amerchol Corporation under the trade name UCARE.

The counterion of the cationic polymer is freely chosen from the halides: chloride, bromide, and iodide; or from hydroxide, phosphate, sulphate, hydrosulphate, ethyl sulphate, methyl sulphate, formate, and acetate.

Non Polysaccharide-Based Cationic Polymers:

A non-polysaccharide-based cationic polymer is comprised of structural units, these structural units may be non-ionic, cationic, anionic or mixtures thereof. The polymer may comprise non-cationic structural units, but the polymer must have a net cationic charge.

The cationic polymer may consists of only one type of structural unit, i.e., the polymer is a homopolymer. The cationic polymer may consists of two types of structural units, i.e., the polymer is a copolymer. The cationic polymer may consists of three types of structural units, i.e., the polymer is a terpolymer. The cationic polymer may comprises two or more types of structural units. The structural units may be described as first structural units, second structural units, third structural units, etc. The structural units, or monomers, may be incorporated in the cationic polymer in a random format or in a block format.

The cationic polymer may comprise a nonionic structural units derived from monomers selected from: (meth)acrylamide, vinyl formamide, N, N-dialkyl acrylamide, N, N-dialkylmethacrylamide, C1-C12 alkyl acrylate, C1-C12 hydroxyalkyl acrylate, polyalkylene glyol acrylate, C1-C12 alkyl methacrylate, C1-C12 hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and mixtures thereof.

The cationic polymer may comprise a cationic structural units derived from monomers selected from: N, N-dialkylaminoalkyl methacrylate, N, N-dialkylaminoalkyl acrylate, N, N-dialkylaminoalkyl acrylamide, N, N-dialkylaminoalkylmethacrylamide, methacylamidoalkyl trialkylammonium salts, acrylamidoalkylltrialkylamminium salts, vinylamine, vinylimine, vinyl imidazole, quaternized vinyl imidazole, diallyl dialkyl ammonium salts, and mixtures thereof.

Preferably, the cationic monomer is selected from: diallyl dimethyl ammonium salts (DADMAS), N, N-dimethyl aminoethyl acrylate, N,N-dimethyl aminoethyl methacrylate (DMAM), [2-(methacryloylamino)ethyl]trl-methylammonium salts, N, N-dimethylaminopropyl acrylamide (DMAPA), N, N-dimethylaminopropyl methacrylamide (DMAPMA), acrylamidopropyl trimethyl ammonium salts (APTAS), methacrylamidopropyl trimethylammonium salts (MAPTAS), quaternized vinylimidazole (QVi), and mixtures thereof.

The cationic polymer may comprise a anionic structural units derived from monomers selected from: acrylic acid (AA), methacrylic acid, maleic acid, vinyl sulfonic acid, styrene sulfonic acid, acrylamidopropylmethane sulfonic acid (AMPS) and their salts, and mixtures thereof.

Some cationic polymers disclosed herein will require stabilisers i.e. materials which will exhibit a yield stress in the ancillary laundry composition of the present invention. Such stabilisers may be selected from: thread like structuring systems for example hydrogenated castor oil or trihydroxystearin e.g. Thixcin ex. Elementis Specialties, crosslinked polyacrylic acid for example Carbopol ex. Lubrizol and gums for example carrageenan.

Preferably the cationic polymer is selected from; cationic polysaccharides and acrylate polymers. More preferably the cationic polymer is a cationic polysaccharide. Even most preferably the cationic polymer is a cationic cellulose or guar. Most preferably the cationic polymer is a cellulose.

The molecular weight of the cationic polymer is preferably greater than 20 000 g/mol, more preferably greater than 25 000 g/mol. The molecular weight is preferably less than 2 000 000 g/mol, more preferably less than 1 000 000 g/mol.

Thickening Polymers

Thickening polymers may be added to the compositions of the invention for further thickening. Any suitable thickener polymer may be used.

Suitable polymers are water soluble or dispersible. A high M.Wt, (for example, in the region of about 100,000 to 5,000,000) which can be achieved by crosslinking, is advantageous. Preferably, the polymer is cationic. Polymers particularly useful in the compositions of the invention include those described in WO2010/078959 (SNF S.A.S.). These are crosslinked water swellable cationic copolymers having at least one cationic monomer and optionally other non-ionic and/or anionic monomers. Preferred polymers of this type are copolymers of acrylamide and trimethylaminoethylacrylate chloride.

Preferred polymers comprise less than 25 percent of water soluble polymers by weight of the total polymer, preferably less than 20 percent, and most preferably less than 15 percent, and a cross-linking agent concentration of from 500 ppm to 5000 ppm relative to the polymer, preferably from 750 ppm to 5000 ppm, more preferably from 1000 to 4500 ppm (as determined by a suitable metering method such as that described on page 8 of patent EP 343840). The cross-linking agent concentration must be higher than about 500 ppm relative to the polymer, and preferably higher than about 750 ppm when the crosslinking agent used is the methylene bisacrylamide, or other cross-linking agents at concentrations that lead to equivalent cross-linking levels of from 10 to 10,000 ppm.

Suitable cationic monomers are selected from the group consisting of the following monomers and derivatives and their quaternary or acid salts: dimethylaminopropylmethacrylamide, dimethylaminopropylacrylamide, diallylamine, methyldiallylamine, dialkylaminoalkyl-acrylates and methacrylates, dialkylaminoalkyl-acrylamides or -methacrylamides.

Following is a non-restrictive list of monomers performing a non-ionic function: acrylamide, methacrylamide, N-Alkyl acrylamide, N-vinyl pyrrolidone, N-vinyl formamide, N-vinyl acetamide, vinylacetate, vinyl alcohol, acrylate esters, allyl alcohol.

Following is a non-restrictive list of monomers performing an anionic function: acrylic acid, methacrylic acid, itaconic acid, crotonic acid, maleic acid, fumaric acid, as well as monomers performing a sulfonic acid or phosphonic acid functions, such as 2-acrylamido-2-methyl propane sulfonic acid (ATBS) etc.

The monomers may also contain hydrophobic groups. Following is a non-restrictive list of cross-linking agents: methylene bisacrylamide (MBA), ethylene glycol diacrylate, polyethylene glycol dimethacrylate, diacrylamide, triallylamine, cyanomethylacrylate, vinyl oxyethylacrylate or methacrylate and formaldehyde, glyoxal, compounds of the glycidyl ether type such as ethyleneglycol diglycidyl ether, or the epoxydes or any other means familiar to the expert permitting cross-linking.

By way of preeminent preference the cross-linking rate preferably ranges from 800 to 5000 ppm (on the basis of methylene bisacrylamide) relative to the polymer or equivalent cross-linking with a cross-linking agent of different efficiency.

As described in US 2002/0132749 and Research Disclosure 4291 16, the degree of non-linearity can additionally be controlled by the inclusion of chain transfer agents (such as isopropyl alcohol, sodium hypophosphite, mercaptoethanol) in the polymerisation mixture in order to control the polymeric chain's length and the cross-linking density. The amount of polymer used in the compositions of the invention is suitably from 0.001 to 0.5 wt. %, preferably from 0.005 to 0.4 wt. %, more preferably from 0.05 to 0.35 wt. % and most preferably from 0.1 to 0.25 wt. %, by weight of the total composition.

An example of a preferred polymer is Flosoft 270LS ex SNF.

Co-Softeners

Co-softeners may be used. When employed, they are typically present at from 0.1 to 20% and particularly at from 0.5 to 10%, based on the total weight of the composition. Preferred co-softeners include fatty esters, and fatty N-oxides. Fatty esters that may be employed include fatty monoesters, such as glycerol monostearate, fatty sugar esters, such as those disclosed WO 01/46361 (Unilever).

The compositions of the present invention may comprise a fatty complexing agent.

Especially suitable fatty complexing agents include fatty alcohols and fatty acids. Of these, fatty alcohols are most preferred.

Without being bound by theory it is believed that the fatty complexing material improves the viscosity profile of the composition by complexing with mono-ester component of the fabric conditioner material thereby providing a composition which has relatively higher levels of di-ester and tri-ester linked components. The di-ester and tri-ester linked components are more stable and do not affect initial viscosity as detrimentally as the mono-ester component.

It is also believed that the higher levels of mono-ester linked component present in compositions comprising quaternary ammonium materials based on TEA may destabilise the composition through depletion flocculation. By using the fatty complexing material to complex with the mono-ester linked component, depletion flocculation is significantly reduced.

In other words, the fatty complexing agent at the increased levels, as required by the present invention, “neutralises” the mono-ester linked component of the quaternary ammonium material. This in situ di-ester generation from mono-ester and fatty alcohol also improves the softening of the composition.

Preferred fatty acids include tallow fatty acid or vegetable fatty acids, particularly preferred are hardened tallow fatty acid or hardened vegetable fatty acid (available under the trade name Pristerene™, ex Croda). Preferred fatty alcohols include tallow alcohol or vegetable alcohol, particularly preferred are hardened tallow alcohol or hardened vegetable alcohol (available under the trade names Stenol™ and Hydrenol™, ex BASF and Laurex™ CS, ex Huntsman).

The fatty complexing agent is preferably present in an amount greater than 0.3 to 5% by weight based on the total weight of the composition. More preferably, the fatty component is present in an amount of from 0.4 to 4%. The weight ratio of the mono-ester component of the quaternary ammonium fabric softening material to the fatty complexing agent is preferably from 5:1 to 1:5, more preferably 4:1 to 1:4, most preferably 3:1 to 1:3, e.g. 2:1 to 1:2.

Non-Ionic Surfactants

The compositions for use as described herein may comprise a nonionic surfactant. Typically, these can be included for the purpose of stabilising the compositions. Suitable nonionic surfactants include addition products of ethylene oxide and/or propylene oxide with fatty alcohols, fatty acids and fatty amines. Any of the alkoxylated materials of the particular type described hereinafter can be used as the nonionic surfactant.

Suitable surfactants are substantially water soluble surfactants of the general formula (VII):

R—Y—(C2H4O)z-CH2-CH2-OH (VII)

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g. 14 to 18 carbon atoms.

In the general formula for the ethoxylated nonionic surfactant, Y is typically:
—O—, —C(O)O—, —C(O)N(R)— or —C(O)N(R)R—
   in which R has the meaning given above for formula (VII), or can be hydrogen; and Z is at least about 8, preferably at least about 10 or 11.

Preferably the nonionic surfactant has an HLB of from about 7 to about 20, more preferably from 10 to 18, e.g. 12 to 16. Genapol™ C200 (Clariant) based on coco chain and 20 EO groups is an example of a suitable nonionic surfactant.

If present, the nonionic surfactant is present in an amount from 0.01 to 10%, more preferably 0.1 to 5 by weight, based on the total weight of the composition.

A class of preferred non-ionic surfactants include addition products of ethylene oxide and/or propylene oxide with fatty alcohols, fatty acids and fatty amines. These are preferably selected from addition products of (a) an alkoxide selected from ethylene oxide, propylene oxide and mixtures thereof with (b) a fatty material selected from fatty alcohols, fatty acids and fatty amines.

Suitable surfactants are substantially water soluble surfactants of the general formula (VIII):

R—Y—(C2H4O)z-CH2-CH2-OH (VIII)

where R is selected from the group consisting of primary, secondary and branched chain alkyl and/or acyl hydrocarbyl groups (when Y═—C(O)O, R≠an acyl hydrocarbyl group); primary, secondary and branched chain alkenyl hydrocarbyl groups; and primary, secondary and branched chain alkenyl-substituted phenolic hydrocarbyl groups; the hydrocarbyl groups having a chain length of from 10 to 60, preferably 10 to 25, e.g. 14 to 20 carbon atoms.

In the general formula for the ethoxylated nonionic surfactant, Y is typically:
—O—, —C(O)O—, —C(O)N(R)— or —C(O)N(R)R—
   in which R has the meaning given above for formula (VIII), or can be hydrogen; and Z is at least about 6, preferably at least about 10 or 11.

Lutensol™ AT25 (BASF) based on C16:18 chain and 25 EO groups is an example of a suitable non-ionic surfactant. Other suitable surfactants include Renex 36 (Trideceth-6), ex Croda; Tergitol 15-S3, ex Dow Chemical Co.; Dihydrol LT7, ex Thai Ethoxylate ltd; Cremophor C040, ex BASF and Neodol 91-8, ex Shell.

Preservatives

The compositions as described herein preferably comprise preservatives, either a single preservative or a combination of preservatives. The level of preservatives is important to ensure preservation both before and after dilution of the concentrated formulations. Two preferred classes of preservatives are organic acid and/or the salts thereof and isothiazolinones. Examples of organic acid and/or the salts thereof are potassium sorbate and sodium benzoate. Examples of isothiazolinones are Methylisothiazolinone (MIT), Chloromethylisothiazolinone (CMIT) and Benzisothiazolinone (BIT). Generally, preservatives are preferably included at an inclusion level of 0.005 to 1 wt. %, more preferably 0.01 to 0.8 wt. %. Preferred inclusion levels of organic acid and/or the salts thereof are 0.05 to 0.8 wt. % and preferred inclusion levels of isothiazolinones is 0.01 to 0.05 wt. %.

Other Ingredients

The compositions as described herein may comprise other ingredients of fabric conditioner liquids as will be known to the person skilled in the art. Among such materials there may be mentioned: antifoams, insect repellents, shading or hueing dyes, preservatives (e.g. bactericides), pH buffering agents, perfume carriers, hydrotropes, anti-redeposition agents, soil-release agents, polyelectrolytes, anti-shrinking agents, anti-wrinkle agents, anti-oxidants, dyes, colorants, sunscreens, anti-corrosion agents, drape imparting agents, anti-static agents, sequestrants and ironing aids. The products of the invention may contain pearlisers and/or opacifiers. A preferred sequestrant is HEDP, an abbreviation for Etidronic acid or 1-hydroxyethane 1,1-diphosphonic acid.

The fabric conditioner composition may be a solid or a liquid. Preferably the composition is a liquid. Preferably the composition is in an aqueous form. The compositions preferably comprise at least 75 wt. % water.

Preparation

The compositions described herein may be prepared via any suitable method. However to maximise stability, preferably the fabric softening active and ester oil are pre-mixed prior to addition to water. Preferably the pre-mixing is performed at a temperature above 50° C., more preferably above 60° C. Once premixed, the ester oil and fabric softening active may be mixed with water.

### Examples

TABLE 1
Example compositions

wt. % inclusion

| | A | 1 |
|---|---|---|
| Fabric Softening active¹ | 8 | 6 |
| Ester oil: Pentaerythritol | — | 0.9 |
| Tetrastearate² | | |
| Cetyl/stearyl alcohol³ | — | 0.5 |
| Perfume | 0.7 | 0.7 |
| Perfume microcapsule | 0.4 | 0.4 |
| Mirrors; antifoam, dyes, pH | <1 | <1 |
| regulators, preservatives etc. | | |
| water | To 100 | To 100 |

Fabric Softening active¹—TEA quaternary ammonium compound according to formula (I) above
Ester oil: Pentaerythritol Tetrastearate²—Priolube 3987 ex. Croda
Cetyl/stearyl alcohol³—viscosity aid

Ester oil: Pentaerythritol Tetrastearate²—Priolube 3987 ex. Croda

Cetyl/stearyl alcohol³—viscosity aid

The compositions were prepared by forming a pre-mix or pre-melt of the fabric softening active and when present ester oil and cetyl/stearyl alcohol. The fabric softening active and when present ester oil and cetyl/stearyl alcohol were heated to ˜65° C. with mixing.

Water was separately heated to ˜ 45° C. The perfume microcapsules and some minors where added to the water with stirring, followed by the premix. The remaining minors were added with stirring, then the water cooled. Finally, the free perfume was added.

The effect of the ester oil in a fabric conditioner assessed using the following washing protocol:
Test fabrics: 3 kg of various fabric monitors and ballast including fabric dyed with
Reactive black 5 dye and EMPA 252 fabric monitors.
Wash cycle: 40° C. cotton cycle
Detergent: 70 g of person non-bio powder added in wash cycle
Fabric conditioner: 55 g of either composition A or 1 added in rinse
Drying: EMPA 253 fabrics line dried, rest tumble dried
Number of washes: 5 or 10

Assessment of colour change was performed using Color i7 Benchtop Spectrophotometer ex. X-rite and is reported using the units ΔE—i.e. colour change between pre-washed fabrics and fabrics washed as above, 5 and 10 times.

TABLE 2
Results of colour fade study

| | ΔE colour change | | | | | |
|---|---|---|---|---|---|---|
| | Black stripe from | | Green stripe from | | Reactive black 5 dye | |
| | EMPA 252 monitor | | EMPA 252 monitor | | monitor | |
| | | 10 | | 10 | | 10 |
| | 5 Washes | Washes | 5 Washes | Washes | 5 Washes | Washes |
| Untreated | 4.973478 | 7.909504 | 7.110302 | 10.46947 | 1.070261 | 1.811872 |
| (no fabric | | | | | | |
| conditioner | | | | | | |
| added) | | | | | | |
| A | 5.536588 | 7.821323 | 7.472547 | 10.41278 | 1.290705 | 2.206307 |
| 1 | 4.854783 | 7.367284 | 6.694306 | 10.02934 | 0.818003 | 1.8201 |

A lower value indicates reduced change in colour, i.e. improved colour maintenance or reduced colour fade. For all three example fabrics, composition 1 provides superior colour maintenance to composition A.

1-10. (canceled)

11. A method of preventing or reducing colour fade of fabric over multiple laundry cycles wherein a composition comprising:
a. fabric softening active;
b. ester oil; and
c. 0.1 to 30 wt. % perfume materials;
is used during the rinse stage of the laundry process and contacted with the fabric, wherein the ester oil is a pentaerythritol ester oil.

12. The method according to claim 11, wherein the method prevents or reduces colour fade over 10 laundry cycles.

13. The method according to claim 11, wherein the fabric is treated with a 10 to 100 ml dose of the composition for a 4 to 7 kg load of fabric.

14. The method according to claim 11, wherein the composition comprises 1 to 80 wt. % fabric softening active.

15. The method according to claim 11, wherein the fabric softening active is a cationic quaternary ammonium compound.

16. The method according to claim 11, wherein the composition comprises 0.25 to 15 wt. % of the ester oil.

17. The method according to claim 11, wherein the ester oil is a polyol ester comprising at least two ester linkages.

18. The method according to claim 11, wherein the composition further comprises a preservative.

19. The method according to claim 11, wherein the composition further comprises glycerol monostearate, or a fatty sugar ester.

20. A method of preparing a composition for preventing or reducing colour fade of fabric in a laundry process comprising the step of premixing fabric softening active and ester oil to form a premix prior to addition to water and wherein the composition comprises:
a. fabric softening active;
b. ester oil; and
c. 0.1 to 30 wt. % perfume materials;
wherein the ester oil is a pentaerythritol ester oil.

21. The method of preparing a composition for preventing or reducing colour fade of fabric in a laundry process according to claim 20 wherein the premixing is performed at a temperature above 50° C.

22. The method of preparing a composition for preventing or reducing colour fade of fabric in a laundry process according to claim 20 wherein the premixing is performed at a temperature above 60° C.

23. The method of preparing a composition for preventing or reducing colour fade of fabric in a laundry process according to claim 20 wherein the composition is in a single unit dose format and encapsulated in a water-soluble film.
